(19) United States
(12) Patent Application Publication
(10) Pub. No.: US 2003/0157890 A1
(43) Pub. Date: Aug. 21, 2003

(54) Equifrequent radio interference unit

(76) Inventor: Peter Chen, Taipei (TW)

Correspondence Address: RABIN & BERDO, P.C., Suite 500, 1101 14th Street, N.W., Washington, DC, 20005, US

(21) Appl. No.: 10/076,295

(22) Filed: Feb. 19, 2002

(51) Int. Cl. H04B 1/10

(52) U.S. Cl. 455/63; 455/91

(57) ABSTRACT

An equifrequent radio interference unit includes a frequency-modulation circuit, a crystal-oscillating and frequency-adjusting circuit, a power-adjusting circuit, a power-output circuit, and a transmitting antenna. The interference unit is provided between two adjacent equifrequent radio-controlled products to continuously transmit carrier-free signals to prevent electric waves radiated from a transmitter for a first product from being received by a receiver on a second product. Therefore, two or more equifrequent radio-controlled apparatus can be closely arranged within a common space to operate normally without being interfered with one another.

### BACKGROUND OF THE INVENTION

The present invention relates to an interference unit, and more particularly to an equifrequent radio interference unit that continuously transmits carrier-free signals to prevent electric waves radiated from a transmitter for a first product from being received by a receiver on a second product, so that two or more radio-controlled products could be closely arranged in a common space to operate normally without being interfered with one another.

The prosperously developed electronic technologies have brought significant innovations to many appliances being used in our daily lives, leading us toward a radio world. For instance, micropower short-wave frequency-modulated digital radio has been employed in various household appliances that are usually closely arranged in a common space. For any two or more equifrequent remote-controlled wireless household appliances, such as two TV sets, two air conditioners, or the like of the same model, closely positioned in the same room, they would usually interfere with one another. For example, when a user wants to turned on one of two closely positioned TV sets with a remote controller, both two TV sets would be turned on. Such problem of mutually interfered household appliances could usually be solved by properly changing the positions of the appliances. However, the same problem is not so easily solved in the case of a business office. In a computerized office, arbitrary change of wireless keyboards and mice might very possibly cause mutual interference of computer-controlled apparatus. In a worse condition, a failed computer system in the office and consequent serious losses might occur. This is why the wireless keyboards and mice are usually suitable for personal computers at home but not in business offices.

Identification codes (ID codes) have been suggested to improve the problem of mutual interference. However, only limited number of ID codes is available. The problem of mutual interference still exists when there are too many users and the available number of IC codes is not sufficient.

It is therefore tried by the inventor to develop an equifrequent radio interference unit to eliminate the problem of mutual interference among equifrequent radio-controlled products.

### SUMMARY OF THE INVENTION

A primary object of the present invention is to provide an equifrequent radio interference unit that is capable of continuously transmitting carrier-free signals to prevent electric waves radiated from a transmitter for a first product from being received by a receiver on a second product, so that two or more radio-controlled products could be closely arranged in a room to operate normally without being interfered with one another.

To achieve the above and other objects, the equifrequent radio interference unit of the present invention includes a frequency-modulation circuit, a crystal-oscillating and frequency-adjusting circuit, a power-adjusting circuit, a power-output circuit, and a transmitting antenna. The interference unit of the present invention could be provided between any two adjacent equifrequent radio-controlled products to continuously transmit carrier-free signals to prevent electric waves radiated from the transmitter for the first product from being received by the receiver on the second product. Therefore, all the equifrequent radio-controlled products closely arranged within a common space could operate normally without being interfered with one another.

### BRIEF DESCRIPTION OF THE DRAWINGS

The structure and the technical means adopted by the present invention to achieve the above and other objects can be best understood by referring to the following detailed description of the preferred embodiments and the accompanying drawing, wherein

FIG. 1 is a block diagram showing circuits and FM modulation of an equifrequent radio interference unit according to the present invention.

### DETAILED DESCRIPTION OF THE PREFERRED EMBODIMENTS

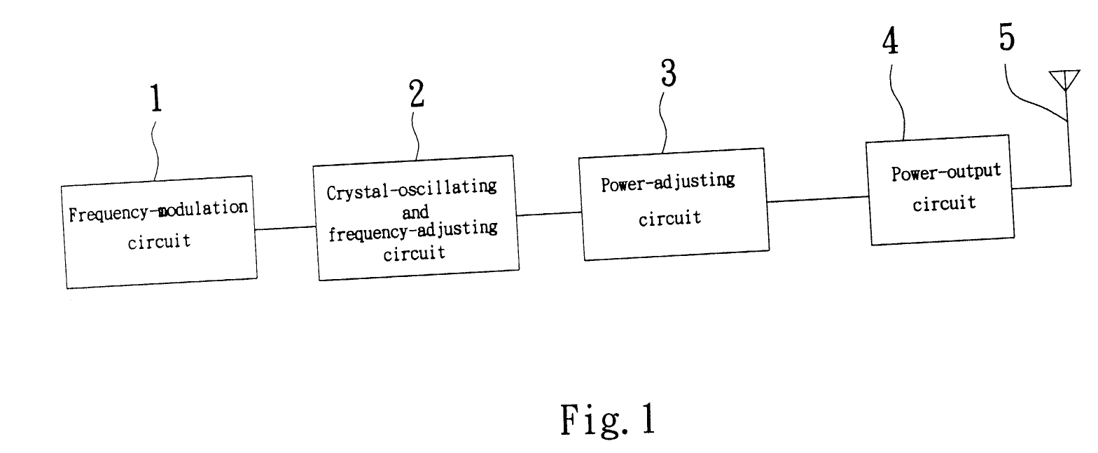

Please refer to FIG. 1 that is a block diagram showing circuits and FM modulation of an equifrequent radio interference unit according to the present invention. As shown, the radio interference unit mainly includes a frequency-modulation circuit 1, a crystal oscillating and frequency-adjusting circuit 2, a power-adjusting circuit 3, a power-output circuit 4, and a transmitting antenna 5.

The frequency-modulation circuit 1 modulates a radio frequency into a predetermined range and limits the crystal oscillating and frequency-adjusting circuit 2 to generate an oscillating frequency within the same predetermined range and to adjust and correct the oscillating frequency for the same to fall into a more accurate range of frequency. The power-adjusting circuit 3 determines an intensity of the oscillating frequency. Generally, a smaller power would have a shorter radiation distance; and a larger power would have a longer radiation distance. When the radio frequency has been adjusted to the desired power intensity, the power-output circuit 4 sends out an equifrequent carrier-free signal via the transmitting antenna 5.

With the above-described arrangements, the interference unit of the present invention could be provided between any two adjacent equifrequent radio-controlled products to continuously transmit carrier-free signals. The interference unit generally has a transmission power lower than that of transmitters for the radio-controlled products, so that signals transmitted from the transmitter of a radio-controlled product is not interfered by the interference unit and could be received and decoded by the receiver on the same radio-controlled product. When a carrier signal transmitted by the transmitter for a first radio-controlled product is radiated to a position beyond a reception range of the receiver on the same product, the carrier signal would become weaker before it arrives at a receiver on a second radio-controlled product due to its smaller power and shorter radiation distance. At this point, the power of the carrier-free signals radiated from the interference unit provided between the first and the second products would become larger than the attenuated power of the carrier signals from the transmitter for the first product. Due to being equifrequent, the carrier-free signals having larger power would supersede the carrier signals having smaller power. In this manner, the electric waves radiated from the transmitter for the first radio-controlled product are prevented from being received by the receiver on the second equifrequent radio-controlled product. Thus, two or more equifrequent radio-controlled apparatus could be closely arranged within a common space to maintain normal operation without being interfered with one another.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An equifrequent radio interference unit, comprising a frequency-modulation circuit, a crystal-oscillating and frequency-adjusting circuit, a power-adjusting circuit, a power-output circuit, and a transmitting antenna; said frequency-modulation circuit modulating a radio frequency into a predetermined range, and limiting said crystal-oscillating and frequency-adjusting circuit to generate an oscillating frequency within said predetermined frequency range and to adjust and correct said oscillating frequency for the same to fall into a more accurate frequency range; said power-adjusting circuit adjusting said corrected oscillating frequency to a desired power intensity depending on a distance by which said frequency is to be transmitted; and said power-output circuit transmitting an equifrequent carrier-free signal via said transmitting antenna after said desired power intensity has been obtained through adjustment by said power-adjusting circuit.
